(19) United States
(12) Patent Application Publication
(10) Pub. No.: US 2009/0265450 A1
(43) Pub. Date: Oct. 22, 2009

(54) METHOD AND APPARATUS FOR MANAGING COMPUTING RESOURCES OF MANAGEMENT SYSTEMS

(76) Inventors: Darren Helmer, Nepean (CA); Raymond Marriner, Perth (CA); Ashok Sadasivan, Sunnyvale, CA (US); Martin Schryburt, Dunrobin (CA); Gurudas Somadder, San Jose, CA (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/104,614

(22) Filed: Apr. 17, 2008

(51) Int. Cl. G06F 15/177; G06F 15/173

(52) U.S. Cl. 709/221; 709/226

(57) ABSTRACT

A method and apparatus for managing resources of a management system is provided. The management system is adapted for managing a network having a plurality of network devices. In one embodiment, the method includes the steps of grouping the network devices into a plurality of network device groups based on at least one characteristic associated with each of the network devices, and allocating respective portions of the resources of the management system to the network device groups. The at least one characteristic of each network device is indicative of an importance of the network device to the provider. The resources are allocated to the network device groups based on the respective importance of each of the network device groups to the provider.

### FIELD OF THE INVENTION

The invention relates to the field of communication networks and, more specifically, to management of computing resources of management systems.

### BACKGROUND OF THE INVENTION

A Network Management System (NMS) is a system for managing a network of devices. An NMS utilizes computing resources (e.g., a combination of hardware and software components) to perform various management functions for the network. An NMS must maintain and represent an accurate status of the network devices of the network in order to effectively manage the network (i.e., the NMS must maintain state synchronization with the network). An NMS consumes computing resources in maintaining state synchronization with the network.

A method of state synchronization that consumes computing resources in an unbounded and/or unpredictable manner often causes the network to become unmanageable due to the NMS running out of available computing resources. Furthermore, certain conditions will exacerbate consumption of the computing resources of the NMS, such as network growth, network device failures, cascading network failures, and the like. These conditions result in an increase in network activity (as the problems are signaled within the network), and, further, also result in a corresponding increase in the activity of the NMS as the NMS attempts to remain synchronized with the network during the network activity.

### SUMMARY OF THE INVENTION

Various deficiencies in the prior art are addressed through a method and apparatus for managing resources of a management system of a provider, where the management system is adapted for managing a network having a plurality of network devices. In one embodiment, the method includes the steps of grouping the network devices into a plurality of network device groups based on at least one characteristic associated with each of the network devices, and allocating respective portions of the resources of the management system to the network device groups. The at least one characteristic of each network device is indicative of an importance of the network device to the provider. The resources are allocated to the network device groups based on the respective importance of each of the network device groups to the provider.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network architecture including a management system managing a network;

FIG. 2 depicts a method for allocating computing resources of the management system for managing the network of FIG. 1; and

FIG. 3 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention enables allocation of the resources of a management system that manages a network of devices. The management system may be under the control of a provider. The network devices are organized into groups, and the resources of the management system are allocated to the groups of network devices, thereby enabling efficient utilization of the resources of the management system. The network device groups may be formed and modified in many ways. The resources may be allocated in numerous ways, including static and/or dynamic allocations. The allocation of the resources may be modified in many ways.

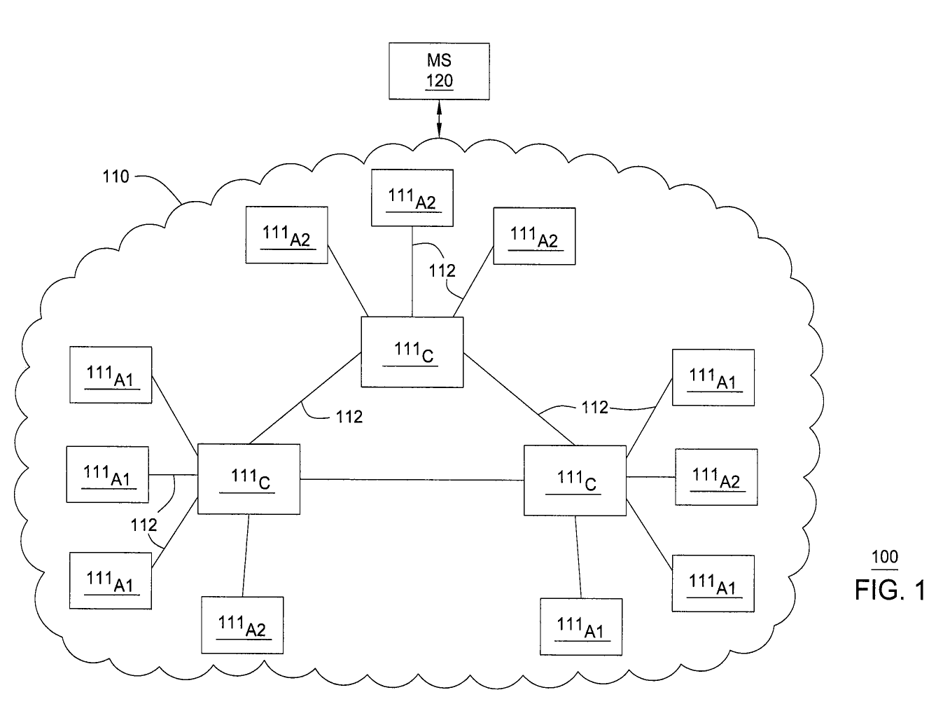

FIG. 1 depicts a high-level block diagram of a communication network architecture. Specifically, the communication network architecture 100 includes a communication network (CN) 110 and a management system (MS) 120. The CN 110 includes a plurality of network devices (NDs) 111. The NDs 111 include a plurality of access devices 111_{A} and a plurality of core devices 111_{C}. The access devices 111_{A} and core device 111_{C} communication using communication links (CLs) 112. The MS 120 manages the NDs 111 and CLs 112 of CN 110.

The MS 120 may be any type of management system. For example, MS 120 may be a network provisioning system, a fault monitoring system, or any other system which may manage other network devices. The MS 120 can manage CN 110 using any management protocol (e.g., Simple Network Management Protocol (SNMP), Common Management Information Protocol (CMIP), Transaction Language 1 (TL1), Extensible Markup Language (XML), and the like). The MS 120 can communicate with NDs 111 of CN 110 using any underlying communications technologies.

The MS 120 may be associated with and/or under the control of any provider. For example, MS 120 may be associated with and/or under the control of a network provider (e.g., a provider which provides the network devices being managed and/or the MS 120 which is used to managed the network devices), a service provider (e.g., a provider which provides one or more services over the network devices being managed by MS 120), a customer (e.g., where the customer is a large enterprise customer performing its own network management functions), and the like, as well as various combinations thereof. The MS 120 may be associated with and/or under the control of any other entity.

The MS 120 may perform many functions. For example, MS 120 may interact with the NDs 111 of CN 110 in order to maintain a current view of the network (i.e., to remain synchronized with the network), perform management functions within the network (e.g., provision connections and services within the network, correlate fault monitoring data received from the network, or any other management functions), and the like, as well as various combinations thereof. The MS 120 may perform any other management functions.

There are many issues associated with managing a network of network devices using a management system, such as in the network depicted and described with respect to FIG. 1.

A management system user typically expects different degrees of responsiveness and state synchronization from the management system based on the role of the target network device. For example, since core devices are more important than access device (due, at least in part, to the capacity of communications supported by the core devices relative to the access devices), a management system user would expect much better responsiveness and more accurate state synchronization for core devices than would be expected for individual ones of the access devices.

A management system typically faces an issue in managing a large network having many network devices providing many different roles within the network (e.g., access, aggregation, edge, core, service applications, and the like). A large network will typically have a much larger number of access devices than edge device and core devices; however, maintaining state synchronization for core device forming the backbone of the network is clearly more important than maintaining state synchronization of individual ones of the access devices (i.e., since failure of one of the core devices would be far more catastrophic than failure of even a number of the access devices).

These issues indicate that network devices must be treated differently within a management system based on characteristics of the network devices (e.g., based on roles of the network devices within the network, capacities supported by the network devices, and the like) because failure to do so would result in consumption of the management system computing resources by the larger number of less important network devices and corresponding computing resource starvation for the smaller number of more important network devices, thereby resulting in a loss of state synchronization of the management system with the more important network devices and, thus, preventing the management system from managing critical services.

These issues manifest themselves in a number of ways during the lifecycle of a management system.

For example, these issues may occur during network discovery, which significantly taxes the management system because of the number of operations that the management system must perform (e.g., creation of objects representing the network devices, database updates, processing event notifications, raising alarms, and the like).

For example, these issues may occur during normal operations. For example, these issues may occur when the management system performs connectivity checks on each of the network devices (e.g., where connectivity checks for the more important network devices are waiting for computing resources of the management system that have been consumed performing connectivity checks on the larger number of less important network devices). These issues may occur during any other normal functions performed by the management system.

For example, these issues may occur during network outages, where a cascading failure of a bunch of less important network devices will cause corresponding processing in the management system to consume all of the available computing resources of the management system. This leaves no computing resources available at the management system for processing information associated with the more important network devices (e.g., for performing database updates, processing notification messages, raising alarms, and performing other required functions)

For example, these issues may occur during loss of synchronization, where the management system realizes that it must react differently to a network device because it is out of synchronization with the network device due to missed synchronization checkpoints. The criteria that the management system uses to decide whether it needs to re-read state information from the network might be different based on the roles and capabilities of different network devices, however, without a capability to vary handling of such situations, the management system would be forced to resort to worst case handling, which would be prohibitively expensive in almost all cases.

For example, these issues may occur due to the latency of the network by which the network devices are connected, which affects the ability of the management system to maintain real-time visibility of network devices. The network latency is affected not only by the latency of interconnections between network devices, but also by the actual data/control plane load on the network devices, such that the management system needs to have a capability to segregate poorly performing portions of the network in a way that prevents the poorly performing portions of the network from affecting the manageability of the rest of the network.

For example, these issues may occur in situations in which the management system must provide preferential treatment to one type of network device over other types of network devices (since treating all network device types equally would still cause resource starvation at the management system). Similarly, these issues also occur in situations in which the management system must provide preferential treatment to one network device within one particular type of network device (since treating all network devices of a given type equally would still cause resource starvation at the management system).

The MS 120 is adapted to support computing resource allocation functions in a dynamic manner in order to alleviate each of the above-described issues and provide many other benefits.

The MS 120 includes computing resources 121 adapted for use in performing such functions. The computing resources 121 may include any resources which may be utilized by MS 120 in managing CN 110. For example, computing resources 121 include processing resources (e.g., CPU resources), memory resources, disk resources, input/output resources, and the like, as well as various combinations thereof. The computing resources 121 may include any other hardware and/or software resources which may be utilized by MS 120 in performing management functions.

The computing resources may be measured in many ways and, thus, may be utilized in many ways. For example, CPU resources may be measured in terms of worker threads available to perform processing functions. For example, memory resources and disk space resources may be measured in terms of capacity. For example, input/output resources may be measure in terms of bandwidth. The computing resources 121 may be measure in many other ways.

The MS 120 is adapted to partition NDs 111 into groups (denoted as network device groups). The NDs 111 may be partitioned into network device groups in many ways. The MS 120 is adapted to allocate different portions of computing resources 121 among the network device groups. The NDs 111 in a network device group may utilize the portions of computing resources 121 allocated to that network device group. The computing resources 121 may be allocated among the network device groups in many ways.

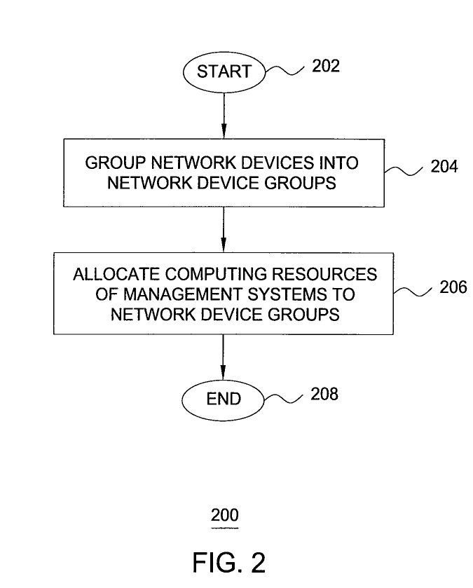

The operation of MS 120 in partitioning NDs 111 into network device groups and allocating computing resources 121 among network device groups may be better understood with respect to FIG. 2.

FIG. 2 depicts a method according to one embodiment of the present invention. Specifically, method 200 of FIG. 2 includes a method for allocating computing resources of a management system to network device groups including network devices of the network managed by the management system. Although depicted and described as being performed serially, at least a portion of the steps of method 200 may be performed contemporaneously, or in a different order than depicted and described with respect to FIG. 2. The method 200 begins at step 202 and proceeds to step 204.

At step 204, network devices are organized into network device groups. The network devices may be organized into the network device groups in a number of ways. In one embodiment, each network device group includes at least one network device. In one embodiment, each network device is assigned to at least one of the network device groups. The network devices may be partitioned into network device groups in many other ways.

The organization of the network devices into network device groups may be based on one or more factors.

In one embodiment, partitioning of network devices into network device groups may be performed by identifying, for each network device, at least one characteristic associated with the network device, and grouping network devices into network device groups based on the determined characteristic(s) of the respective network devices.

The characteristic(s) of a network device that is used to determine the network device group to which that network device is assigned may include one or more of a role of the network device within the network, a set of capabilities supported by the network device, a set of services supported by the network device, a customer or set of customers supported by the network device, a type of technology of the network device, a capacity of the network device, a geographic location at which the network device is deployed, and the like, as well as various combinations thereof.

The characteristic(s) of a network device that is used to determine the network device group to which that network device is assigned may be indicative of an importance of the network device to the network (relative to other network devices in the network), and, thus, the importance of the network device to the service provider. In one embodiment, an importance measure may be assigned to the network device based on the one or more characteristics (and also taking into account importance levels assigned to other network elements since importance of network devices within the network is relative).

Thus, since each network device has an associated importance that is based on the characteristic(s) used to assign the network device to a network device group, and since like network devices having similar characteristics may be grouped into the same network device groups, the importance of each network device group (relative to other network device groups) may be determined based on the importance of the respective constituent network devices of the network device groups and, further, the importance of each network device group may be used to determine allocation of computing resources among the network device groups.

The network device groups may be modified. An existing network device group may be split to form multiple network device groups or multiple network device groups may be merged to form fewer network device groups. An existing network device group may be deleted (and, optionally, if the network devices remain active in the network, the network device may be reassigned to other groups). A new network device group may be created (e.g., including new network devices or network device from other groups). The membership of existing network device groups may be modified (e.g., one or more network devices may be reassigned from one network device group to one or more other network device groups).

The modification of network device groups may be performed in response to one or more events. For example, network device groups may be modified in response to customer desires or needs, changes to the topology of the network (e.g., where older network resources are demoted due to the addition of newer, more important network resources), changes to services supported by the network, and the like, as well as various combinations thereof.

The modification of network device groups may be performed based on any information (e.g., information associated with the network device groups prior to modification, information associated with the event that triggers the modification of the network device groups, and the like, as well as various combinations thereof). The modification of network device groups may be performed at any time (e.g., prior to runtime and/or at runtime, and may continue to be performed as needed and/or desired).

The network devices may organized into network device groups with any granularity. Thus, organization of network devices into network device groups is not limited to embodiments in which each network device is assigned to one of the network device groups as a complete unit. In one embodiment, for example, portions of networks device may be independently assignable (e.g., network elements may be assignable at the chassis level, shelf level, slot level, and the like). In one embodiment, for example, groups of network devices may be assignable to a network device group.

At step 206, resources of the management system are allocated to the network device groups.

The resources may be allocated to the network device groups in a number of ways.

In one embodiment, resources of the management system may be allocated by determining a total amount of resources available to be allocated by the management system, and allocating respective portions of the total amount of resources to the network device groups. In one embodiment, for example, the resources of the management system may be allocated based on the respective importance levels of the network device groups. In one embodiment, for example, the resources of the management system may be allocated based on respective amounts of resources expected or predicted to be used or needed by the network device groups. The total amount of resources may be allocated based on various other factors.

In one embodiment, resources of the management system may be allocated to network device groups using resource groups. In one such embodiment, resources of the management system may be allocated by assigning resources of the management system to resource groups, and associating the resource groups and the network device groups such that each network device group may utilize the resources of the resource group(s) with which that network device is associated.

The resources of the management system may be assigned to the resource groups in any manner. In one embodiment, total available resources of the management system are determined and the total available resources are apportioned among resource groups. The total available resources may be apportioned among the resource groups in any manner (e.g., based on an importance of the network device group(s) with which each resource group is expected to be associated, based on resource utilization data measured on the management system, and the like).

The resource groups and the network device groups may be associated in any manner. In one embodiment, resource groups are assigned to network device groups (e.g., each resource group is assigned to provide resources for one or more of the network device groups). In one embodiment, network device groups are assigned to resource groups (e.g., each network device group is assigned to one or more of the resource groups). The resource groups and the network device groups may be associated in many other ways.

The associations between the resource groups and the network device groups may be modified. A resource group may be reassigned from serving one or more network device groups to serving one or more other network device groups. A network device group may be reassigned from being served by one or more resource groups to being served by one or more other resource groups.

The modification of associations between the resource groups and the network device groups may be performed at any time and for any reason.

The modification of associations between resource groups and network device groups supports situations in which the relative importance of different network devices of the same type can be different based on customer needs. This would be handled by allowing a network device(s) or network device group(s) to be moved to a different resource group(s) at runtime

The modification of associations between resource groups and network device groups supports situations in which a network device(s) of a network device group(s) needs to be temporarily isolated for one or more reasons (e.g., because associated communication latency of the target network device(s) is affecting the rest of the network devices in the group).

The modification of associations between resource groups and network device groups may be helpful in various other situations.

In one embodiment, in which allocation of management system resources is performed using resource groups, the resource groups may be modified.

The resource groups may be modified in many ways. An existing resource group may be split to form multiple resource groups or multiple resource groups may be merged to form fewer resource groups. An existing resource group may be deleted (and the associated resources reassigned to other groups). A new resource group may be created (e.g., including new resources or resources from other groups). The composition of existing resource groups may be modified (e.g., one or more resources may be reassigned from one resource group to one or more other resource groups).

The modification of resource groups may be performed in response to one or more events. For example, resource groups may be modified in response to one or more of modifications to the available resources of the management system, modifications to the network device groups (which may be modified in response to various other events described herein), resource utilization information measured at the management system (e.g., based on interactions of the management system with the network), and the like, as well as various combinations thereof.

The modification of resource groups may be performed based on any information (e.g., information associated with the resource groups before they are modified, information associated with the event that triggers the modification, information associated with the network device groups, and the like, as well as various combinations thereof). The modification of resource groups may be performed at any time (e.g., prior to runtime and/or at runtime, and may continue to be performed as desired and/or needed).

The allocation of network resources of the management system to network device groups may be static and/or dynamic (such that borrowing and lending of resources between groups is or is not permitted). The network device groups may all have static allocations of resources such that borrowing of resources between network device groups is not permitted. The network device groups may all have dynamic allocations of resources such that borrowing of resources between network device groups is permitted. A combination of such static allocations and dynamic allocations may be supported for different network device groups formed for a management system.

A network device group may be restricted from borrowing resources from other network device groups under any circumstances. A network device group may be restricted from borrowing resources from other network device groups unless a condition (or conditions) is satisfied. A network device group may be permitted to borrow resources from one other network device group. A network device group may be permitted to borrow resources from multiple other network device groups (e.g., equally without any priority specified, in a priority order such that the network device group will borrow from certain network device groups before borrowing from other network device groups, and the like, as well as various combinations thereof).

A network device group may be permitted to borrow all resources of another network device group(s). A network device group may be permitted to borrow all available resources of another network device group(s). A network device group may be permitted to borrow resources of another network device group(s) for as long as needed. A network device group may be permitted to borrow resources of another network device group until those resources are needed by the other network device group. A network device may borrow resources of one or more other network device groups in many other ways.

As an example, referring to FIG. 1, assume that a first network device group includes access devices 111_{A} and a second network device group includes core devices 111_{C}. As one example, the first network device group may be prevented from borrow resources from the second network device group, but the second network device group may be permitted to borrow resources from the first network device groups (e.g., to ensure that there are always enough resources available for the more important core devices). As another example, the first network device group may be permitted to borrow 10% of the available resources of the second network device group, while the second network device group is permitted to borrow any available resources of the first network device group. The resources may be borrowed/shared in many other ways.

In other words, a network device group is allowed to temporarily exceed the resources assigned to the network device group (e.g., resources assigned to one network device group may temporarily utilize resources that are assigned to one or more other network device groups, but that are not currently being used by the one or more other network device groups). In this manner, all available resources of the management system may be utilized as long as there is some function to be performed, while also maintaining the allocation of the resources of the management system to the network device groups.

In such embodiments, in other words, under certain conditions, some network device groups may temporarily borrow resources assigned to other network device groups (and return the borrowed resources either when they are no longer required, or when the network device group(s) lending the resources needs those resources). For example, one network device group may borrow resources one or more other network device groups in response to peak network traffic conditions, in response to network failure conditions, and the like, as well as various combinations thereof.

In one embodiment, allocation of resources among the network device groups may be modified (e.g., not temporarily, where one network device group borrows resources of one or more other network device groups, but, rather, permanently where the baseline allocation of resources to the network device group is modified). This reallocation is permanent in that the management system will not revert to the previous allocation when the condition that triggered the reallocation clears; however, it should be noted that the permanent reallocation of resources of the management system may continue to be modified temporarily (i.e., where network device groups borrow resources from each other) and permanently. The reallocation may be performed automatically (e.g., in response to one or more conditions) and/or manually (e.g., by one or more administrators of the service provider).

In one such embodiment, reallocation of resources among the network device groups may be performed by collecting resource utilization data (at the management system) based on interactions of the management systems with the network (e.g., by initiating a network discovery process, or any other means of collecting such data), and reallocating at least a portion of the resources among at least a portion of the network device groups based on the resource utilization data. This reallocation of resources may be performed at runtime, and may continue to be performed as needed. This reallocation of resources provides a larger margin of error in the initial estimates of resource allocation made before runtime since these initial allocations may be modified in real time based on measured resource utilization data.

In another such embodiment, reallocation of resources among the network device groups may be performed in response to detecting that one or more network device groups is regularly borrowing resources allocated to one or more other network device groups. This condition may be measured in any manner (e.g., the number of times that a network device group borrows resources in a given period of time, the amount of resources that a network device group borrows in a given period of time and the like, as well as various combinations thereof). This condition may be determined in any manner (e.g., using counters, thresholds, and the like, as well as various combinations thereof).

The permanent reallocation of resources among the network device groups may be performed in response to many other conditions. For example, reallocation of resources among the network device groups may be performed in response to one or more of a change to the network device groups, a change in the total amount of resources of the management system, a change to the composition of the network (e.g., in terms of numbers of different types of network devices deployed in the network), and the like, as well as various combinations thereof). The reallocation of resources among the network device groups may be performed in many other ways.

In some embodiments, in which resources of the management system are allocated to different resource groups, one or more of the resource groups may be permitted to exceed its allocation of resources. A resource group may be permitted to exceed its allocation only if other resource groups are not affected (which may be all other resource groups, some of the other resource groups, and the like). A resource group may be permitted to exceed its allocation regardless of whether or not other resource groups are affected (which may be all other resource groups, some of the other resource groups, and the like).

In some embodiments, in which resources of the management system are allocated to different resource groups, allocation of resources among the resource groups may be modified (e.g., not temporarily, where one resource group borrows resources of one or more other resource groups, but, rather, permanently where the baseline allocation of resources to the resource group is permanently modified in that the management system will not revert to the previous allocation when the condition that triggered the reallocation clears). The reallocation of resources among resource groups may be performed automatically (e.g., in response to one or more conditions) and/or manually (e.g., by one or more administrators of the service provider).

In such embodiments, the reallocation of resources among resource groups may be performed by collecting resource utilization data based on interactions of the management systems with the network (e.g., so that an inefficiently configured management system can self-tune its allocation of resources to resource groups as appropriate based on management system activity), in response to detecting that one or more resource groups is regularly borrowing resources allocated to one or more other resource groups, in response to a change to the network device groups, in response to a change in the total amount of resources of the management system, in response to a change to the composition of the network, and the like, as well as various combinations thereof). The reallocation of resources among the resource groups may be performed in many other ways.

In other words, in embodiments in which resources of the management system are allocated to different resource groups, the resource groups may be managed in a manner similar to the manner in which network device groups may be managed (e.g., enabling various combinations of temporary borrowing of resources, permanent reallocation of resources, and the like, as well as various combinations thereof).

In such embodiments, management of the resource group may be performed in place of management of network device groups and/or group may be performed in conjunction with management of network device groups. Thus, in this manner, the management system is provided complete flexibility to manage resources in a manner tending to optimize total system throughput of the management system.

In one embodiment, the total available resources of the management system may be modified. The total available resource may be increased or decreased at any time. The total available resources may be modified for any reason (e.g., anticipated need, detected need, and the like). For example, the CPU resources may be increased in anticipation of the addition of new network devices to the network. For example, the disk space of the management system may be decreased in response to a determination that disk space never even approaches full utilization under worst case conditions. In one embodiment, the total available resources of the management system may be modified in response to a change in the resource groups generated for the management system (e.g., in response to deletion/creation of resource groups). The modification of the total available resources of the management system may trigger any other modifications described herein (e.g., modification of one or more network device groups, modification of one or more resource groups, modification of resource allocation, and the like, as well as various combinations thereof).

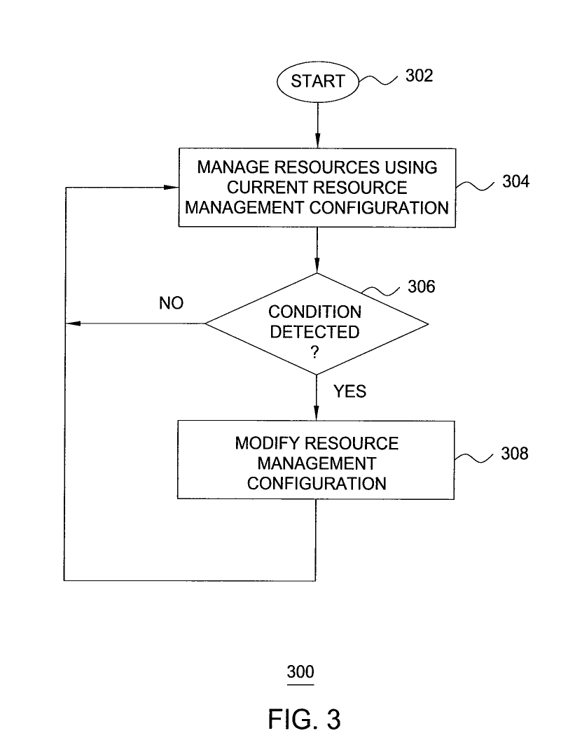

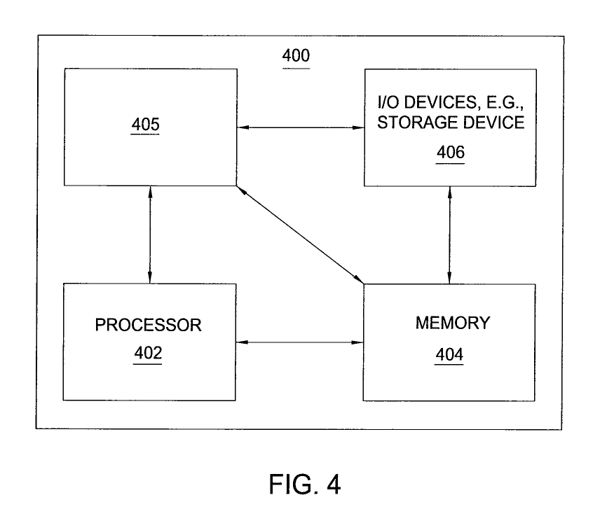

At step 208, method 200 ends. Although depicted and described as ending (for purposes of clarity), the allocation of resources to network device groups that results from execution of method 200 may continue to be modified as needed or desired. A method for modifying management of resources of a management system is depicted and described herein with respect to FIG. 3.

With respect to FIG. 2, as one example, referring to FIG. 1, access devices 111_{A} may be assigned to a first network device group (based on their respective roles as access devices) and core devices 111_{C} may be assigned to a second network device group (based on their respective roles as core devices). In this example, since the core devices 111_{C} are deemed more important than the access devices 111_{A}, the second network device group is deemed to be more important than the first network device group, and, thus, more of the computing resources 121 may be allocated to the second network device group than to the first network device group.

With respect to FIG. 2, as another example, again referring to FIG. 1, access devices 111_{A1} may be assigned to a first network device group (based on their roles as access devices and that they support services for an important client), access devices 111_{A2} may be assigned to a second network device group (based on their respective roles as access devices and that they support services for smaller, less important clients), and core devices 111_{C} may be assigned to a third network device group (based on their roles as core devices). In this embodiment, the relative importance of the network device groups may be ranked as follows: third network device group (highest), first network device group, second network device group (lowest), and, thus, computing resources 121 may be allocated accordingly.

In continuation of the first example, since the core devices 111_{C} are deemed to be more important than the access devices 111_{A}, more of the computing resources 121 of management system 120 may be allocated to the first network device group than to the second network device group. For example, 70% of the CPU resources, 70% of the memory resources, 40% of the disk space resources, and 40% of the input-output resources may be assigned to the first network device group, while the remaining computing resources 121 (i.e., 30% of the CPU resources, 30% of the memory resources, 60% of the disk space resources, and 60% of the input-output resources) may be assigned to the second network device group.

FIG. 3 depicts a method according to one embodiment of the present invention. Specifically, method 300 of FIG. 3 includes a method for dynamically modifying management of the computing resources of a management system. Although depicted and described as being performed serially, at least a portion of the steps of method 300 may be performed contemporaneously, or in a different order than depicted and described with respect to FIG. 3. The method 300 begins at step 302 and proceeds to step 304.

At step 304, resources of the management system are managed using the current resource management configuration. For example, the resources of the management system are managed based on the currently established network device groups, resource allocations to the existing device groups, and the like.

At step 306, a determination is made as to whether a condition is detected. If a condition is not detected, method 300 returns to step 304 (i.e., the resources of the management system continue to be managed according to the current configuration until an event that triggers a change to the current configuration is detected). If a condition is detected, method 300 proceeds to step 308.

The condition may be any condition which may trigger modification of the current resource management configuration. For example, the condition may be one or more of an event in the network, a change in the network (e.g., addition/removal of network devices from the network, changed to the network topology, addition/removal of services supported by the network, and the like), a change in the computing resources of the management system, resource utilization information for the management system, a change request entered by a user, and the like.

At step 308, the resource management configuration is modified (i.e., management of the resources of the management system is modified).

The management of the resource of the management system may be modified in many ways. For example, management of the resources of the management system may be modified by one or more of changing network device groups, changing resource groups, reallocating resources among resource groups, temporarily reallocating resources between network device groups, permanently reallocating resources between network device groups, and the like, as well as various combinations thereof.

From step 308, method 300 returns to step 304, such that the resources of the management system continue to be managed according to the current configuration until detection of the next event that triggers a change to the current configuration. In this manner, the resources of the management system may continue to be managed on an ongoing basis, as needed or desired, in order to ensure the most efficient possible use of the resources of the management system in support of the management functions provided by the management system.

FIG. 4 depicts a high-level block diagram of a general-purpose computer suitable for use in performing the functions described herein. As depicted in FIG. 4, system 400 comprises a processor element 402 (e.g., a CPU), a memory 404, e.g., random access memory (RAM) and/or read only memory (ROM), a resource allocation module 405, and various input/output devices 406 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the resource allocation process 405 can be loaded into memory 404 and executed by processor 402 to implement the functions as discussed above. As such, resource allocation process 405 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although primarily depicted and described herein with respect to embodiments in which the management system manages a network of communications devices, the resource allocation functions depicted and described herein may be utilized to allocate resources of any management system responsible for managing any types of devices.

Although various embodiments which incorporate the teachings of the present invention have been shown and described in detail herein, those skilled in the art can readily devise many other varied embodiments that still incorporate these teachings.

What is claimed is:

1. A method for managing resources of a management system of a provider, the management system adapted for managing a network having a plurality of network devices, the method comprising:
grouping the network devices into a plurality of network device groups based on at least one characteristic associated with each of the network devices, wherein the at least one characteristic of each network device is indicative of an importance of the network device to the provider; and
allocating respective portions of the resources of the management system to the network device groups based on a respective importance of each network device group to the provider.

2. The method of claim 1, wherein the at least one characteristic comprises at least one of a role of the network device within the network, a set of capabilities of the network device, a function supported by the network device, a service supported by the network device, a capacity of the network device, and an importance of the network device to the provider.

3. The method of claim 1, wherein the resources comprise at least one of central processing unit (CPU) resources, memory resources, disk space resources, and I/O bandwidth resources.

4. The method of claim 1, wherein allocation of the resources of the management system to at least one of the network device groups is static.

5. The method of claim 1, wherein allocation of the resources of the management system to at least one of the network device groups is dynamic.

6. The method of claim 1, wherein allocating the resources comprises:
determining a total amount of resources available to be allocated by the management system; and
allocating respective portions of the total amount of resources to the network device groups based on the respective importance of each of the network device groups.

7. The method of claim 6, further comprising:
reallocating respective portions of the resources to the network device groups in response to a determination that the total amount of resources of the management system has changed.

8. The method of claim 1, wherein allocating the resources comprises:
allocating the resources of the management system among a plurality of resource groups; and
associating each network device group with at least one of the resource groups.

9. The method of claim 8, further comprising:
changing one of the network device groups from being associated with a first one of the resource groups to being associated with a second one of the resource groups; or
changing one of the resource groups from being associated with a first one of the network device groups to being associated with a second one of the network device groups.

10. The method of claim 8, further comprising:
reallocating at least a portion of the resources allocated to at least one of the resource groups to at least another of the resource groups.

11. The method of claim 10, wherein the reallocation is temporary or permanent.

12. The method of claim 10, wherein the reallocation is performed in response to at least one of a change in a total amount of resources of the management system, a change in a topology of the network, a service failure, a network device failure, a communication link failure, a modification of at least one resource group used to allocate the resources to the network device groups, and measured activity of the management system.

13. The method of claim 1, wherein at least one of the network device groups is permitted to borrow resources from at least another of the network device groups.

14. The method of claim 1, further comprising:
reallocating at least a portion of the resources allocated to at least one of the network device groups to at least another of the network device groups.

15. The method of claim 14, wherein the reallocation is temporary or permanent.

16. The method of claim 14, wherein the reallocation is performed in response to at least one of a change in a total amount of resources of the management system, a change in a topology of the network, a service failure, a network device failure, a communication link failure, a modification of at least one resource group used to allocate the resources to the network device groups, and measured activity of the management system.

17. The method of claim 1, further comprising:
temporarily reallocating at least a portion of the resources allocated to a first one of the network device groups to a second one of the network device groups.

18. The method of claim 17, wherein the resources are temporarily reallocated in response to an event.

19. The method of claim 18, wherein the event comprises at least one of a service failure, a network device failure, and a communication link failure.

20. The method of claim 17, further comprising:
releasing, by the second one of the network device groups, the resources temporarily reallocated from the first one of the network device groups.

21. The method of claim 20, wherein the resources are released in response to a determination that the second one of the network device groups no longer requires the resources reallocated from the first one of the network device groups or in response to a request by the first one of the network device groups.

22. The method of claim 1, further comprising:
permanently reallocating at least a portion of the resources allocated to a first one of the network device groups to a second one of the network device groups.

23. The method of claim 22, wherein the resources are permanently reallocated in response to an event.

24. The method of claim 23, wherein the event comprises at least one of a change in a total amount of resources of the management system, a change in a topology of the network, a modification of at least one resource group used to allocate the resources to the network device groups, and measured activity of the management system.

25. The method of claim 1, further comprising:
collecting resource utilization data at the management system based on interactions of the management system with the network devices; and
reallocating at least a portion of the resources among at least a portion of the network device groups based on the resource utilization data.

26. The method of claim 1, further comprising at least one of:
modifying at least one of the network device groups;
creating at least one new network device group;
deleting at least one of the network device groups.
merging at least two of the network device groups;
splitting one of the network device groups into a plurality of network device groups; and
moving at least one of the network devices from one of the network device groups to another of the network device groups.

27. A computer readable medium storing a software program which, when executed by a computer, causes the computer to perform a method for managing resources of a management system of a provider, the management system adapted for managing a network having a plurality of network devices, the method comprising:
grouping the network devices into a plurality of network device groups based on at least one characteristic associated with each of the network devices, wherein the at least one characteristic of each network device is indicative of an importance of the network device to the provider; and
allocating respective portions of the resources of the management system to the network device groups based on a respective importance of each network device group to the provider.

28. An apparatus for managing resources of a management system of a provider, the management system adapted for managing a network having a plurality of network devices, the apparatus comprising:
means for grouping the network devices into a plurality of network device groups based on at least one characteristic associated with each of the network devices, wherein the at least one characteristic of each network device is indicative of an importance of the network device to the provider; and
means for allocating respective portions of the resources of the management system to the network device groups based on a respective importance of each network device group to the provider.
